(19) United States
(12) Patent Application Publication
(10) Pub. No.: US 2024/0367898 A1
(43) Pub. Date: Nov. 7, 2024

(54) A LOCK FOR A BIN AND METHOD OF CONTROLLING ACCESS TO A BIN

(71) Applicant: FOCUS BINS AUSTRALIA PTY LTD, Granville, New South Wales (AU)

(72) Inventors: Manjit SINGH, Granville, New South Wales (AU); Alejandro MÉNDEZ, Granville, New South Wales (AU); Samuel PEREZ, Granville, New South Wales (AU); Dimiter NEDIALKOV, Granville, New South Wales (AU); Brandon YU, Granville, New South Wales (AU)

(21) Appl. No.: 18/683,310

(22) PCT Filed: Aug. 13, 2021
(86) PCT No.: PCT/AU2021/050899

§ 371 Date: Feb. 13, 2024

(51) Int. Cl. B65F 1/16

(52) U.S. Cl. CPC B65F 1/1615; B65F 2210/108; B65F 2210/128; B65F 2210/148

(57) ABSTRACT

A lock system is described which includes a range monitoring system including a computer processor to monitor the proximity of the bin to a base station; a collection monitoring module including a computer processor to monitor when the bin is being collected. Also described is a computer-controlled method of inhibiting bin access to unauthorised persons, the method includes the steps of monitoring proximity of a bin to a base station with a range monitor having a computer processor to monitor the proximity of the bin; monitoring bin collection movement with a computer processor having a lift monitor, and unlocking a bin lock with a computer controller when the range monitor detects that the bin is proximal a base station and locking the bin lock when the range monitor detects that the bin is distal the base station.

### TECHNICAL FIELD

The present technology relates generally to a lock system for a bin, which allows free loading of a bin when it is home, but locks them on the street until pickup by a garbage truck.

### BACKGROUND

On occasion, neighbours with excess rubbish will nonchanlantly, perhaps guiltily, meander along their street on bin night, looking to deposit that excess refuse in someone else's bin. That excess refuse can be unwelcome in the other person's bin: it can stink, or it can be poorly-bagged, it can encourage vermin, and spread disease.

On other occasions, perhaps even the same occasion later that night, animals or even people may rummage through that other person's bin, spreading it on their lawn, spreading disease and increasing the workload of the next morning.

These situations are clearly undesirable.

There are known bin locks for controlling access to bins when in a collecting zone, but they are oversimplified and do not adapt to a situation where animals may knock a bin over-they open at the wrong times, spilling refuse around the street before collection, or may maintain the bin in a locked state when an authorised person does come to empty the bin.

The present inventor seeks to provide a lock for a bin which grants access to authorised users of a bin, and limits bin access to unauthorised users, and/or which at least provides a useful alternative to known locks.

### SUMMARY

Broadly, the present technology provides a bin lock which is configured to grant access only to authorised users of the bin.

Broadly, the present technology maintains a bin in an unlocked state near a base station but locks the bin when it moves a selected distance from a base station.

Broadly, the present technology provides a bin lock system which allows relatively free or unlocked access to a bin when it is proximal a base station, but limits access only to authorised refuse collectors when it is in a collection zone remote from the base station.

In accordance with one aspect of the present technology there is provided a computer controlled lock system for a bin, the lock system including:
a lock arrangement including a computer processor configured to be in wireless data communication with a mobile device to unlock the bin in response to a wireless command from the mobile device when the bin is being collected, and to lock the bin when the bin is not being collected.

In one embodiment the lock arrangement includes a processor with a timer so that the lock arrangement is configured to open for a selected time period in response to an unlock command from the mobile device.

In one embodiment the lock arrangement includes an authentication module which is configured to receive a BLE key data signal and compare it to a database in which is stored a plurality of key code data strings to authenticate the BLE key data.

In one embodiment the key code data string stored in the database is a 32-bit data string.

In one embodiment there are stored in the database between 10 and 200 different 32-bit data string key codes.

In accordance with one aspect of the present technology there is provided a computer-controlled lock system for a bin, the lock system including:
a movement monitoring module including an accelerometer and a computer processor to monitor when the bin is being collected,
a lock arrangement in communication with the movement monitoring module configured to unlock the bin when the bin is being collected, and to lock the bin when the bin is not being collected.

In one embodiment there is provided a range monitoring system including a computer processor to monitor the proximity of the bin to a base station.

In one embodiment the range monitoring system includes a wireless module for receiving and measuring the strength of wireless signals from a base station.

In one embodiment the wireless module includes a BLE receiver.

In one embodiment the wireless module includes a BLE unit configured to operate in advertising mode.

In one embodiment the range monitoring system is configured to receive a BLE data signal which includes threshold radio signal strength data, and assess the signal strength data with the measured strength, to output a home zone data element if the measured strength is above the threshold data set in the message, and an out-of-home zone data element if the measured strength is below the threshold data in the message.

In one embodiment there is provided a base station which is configured to transmit a threshold data signal.

In one embodiment the base station includes a volume control to vary the power of the threshold data signal.

In one embodiment the volume control is in the form of up and down buttons.

In one embodiment the threshold data signal includes a key code for security.

In one embodiment the lock arrangement includes a key management module.

In one embodiment the key management module includes an actuator.

In one embodiment the actuator is in the form of a button.

In one embodiment the key management module is configured such that a long press on the button will erase all key data strings from a key database except for a master key data string.

In one embodiment the key management module includes a key configuration routine.

In one embodiment the key management module is configured to add keys in the key configuration routine by responding to a short press of the button to cause the key data contained in any incoming message that bears the “remember me” data flag to be saved in the key database table.

In one embodiment the accelerometer includes a trigger unit which includes a sensing module which activates the computer processor of the movement monitoring module to commence sampling data from the accelerometer.

In one embodiment the movement monitoring module records a sample of data from the accelerometer and conducts numerical integration on the sample to compare it with a threshold to provide a threshold comparison output data.

In one embodiment the movement monitoring module sends the threshold comparison output data to a lock control module.

In one embodiment the lock control module includes a latch state detector configured to detect whether the latch is in a locked position or in an unlocked position.

In one embodiment the latch state detector is configured to record the latch state in an onboard memory.

In one embodiment the lock control module includes a zone detector configured to detect whether the lock is in a home zone proximal a base station or whether the lock is in an out of home zone distal the base station.

In one embodiment the lock control module is configured to record whether the lock is in the home zone or in the out of home zone, in memory.

In one embodiment a latch is provided which is configured to be rotatably driven by a motor between a locked position.

In one embodiment a lock housing is provided that includes shoulders to protect the latch when the bin is inverted for cleaning.

In one embodiment the lock system includes a catch which is movable for manual release, such that it can move between a locked position and an unlocked position.

In one embodiment the catch is configured to be unlocked from the outside or the inside of the bin.

In one embodiment the external actuator is a key, which cooperates with a lock and includes a detent so as to be retainable in the lock when the key is turned to the unlock position.

In one embodiment the lock includes a cam which operates on a follower to push against a biasing force in the form of springs.

In one embodiment there is provided a catch safety release.

In one embodiment the follower is manually operable by an actuator handle in order to release from the inside.

In one embodiment the handle slides the catch away from the latch to release.

In accordance with one aspect of the present technology there is provided a computer-controlled lock system for a bin, the lock system including:
a range monitoring system including a computer processor to monitor the proximity of the bin to a base station;
a movement monitoring module including a computer processor to monitor when the bin is being collected,
a lock arrangement in communication with the range monitoring system and the collection monitoring module to unlock the bin when the bin is proximal the base station and when the bin is being collected, and to lock the bin when the bin is distal the base station and not being collected.

A computer-controlled method of inhibiting bin access to unauthorised persons, the method including the steps of:
actuating in a computer processor proximity card reader module; and
unlocking a bin lock with the computer controller when the computer processor receives data from the proximity card reader module that an authorised user is standing next to the bin.

In accordance with one aspect of the present technology there is provided a computer-controlled lock system for a bin, the lock system including:
a proximity card reader;
a computer processor in communication with the proximity card reader;
a lock arrangement in communication with the proximity card reader to unlock the bin when the proximity card reader sends card data to the computer processor which matches that of an authorised user.

In accordance with another aspect of the present technology there is provided a computer-controlled method of inhibiting bin access to unauthorised persons, the method including the steps of:
monitoring bin collection movement with a computer processor having a lift monitor; and
unlocking a bin lock with a computer controller when the computer processor receives data from the lift monitor that the bin is being collected and locking the bin lock when the computer processor receives data from the lift monitor that the bin is not being collected.

In accordance with another aspect of the present technology there is provided a computer-controlled method of inhibiting bin access to unauthorised persons, the method including the steps of:
monitoring users' biometric features with a biometric reader; and
unlocking a bin lock with a computer controller when the computer processor receives biometric data from the biometric reader which matches that of an authorised person.

In accordance with one aspect of the present technology there is provided a computer-controlled lock system for a bin, the lock system including:
a biometric reader
a computer processor in communication with the biometric reader;
a lock arrangement in communication with the biometric reader to unlock the bin when the biometric reader sends data to the computer processor which matches that of an authorised user.

In accordance with another aspect of the present technology there is provided a computer-controlled method of inhibiting bin access to unauthorised persons, the method including the steps of:
monitoring proximity of a bin to a base station with a range monitor having a computer processor to monitor proximity of the bin;
monitoring bin collection movement with a computer processor having a lift monitor; and
unlocking a bin lock with a computer controller when the range monitor detects that the bin is proximal a base station and locking the bin lock when the range monitor detects that the bin is distal the base station.

In accordance with yet another aspect of the present technology there is provided a computer-controlled method of inhibiting bin access to unauthorised persons, the method including the steps of:
monitoring proximity of a bin to a base station with a range monitor having a computer processor to monitor proximity of the bin;
monitoring bin collection movement with a computer processor having a lift monitor; and
unlocking the bin lock with a computer controller when the lift monitor detects that the bin is being lifted and the range monitor detects that the bin is distal the base station.

In accordance with yet another aspect of the present technology there is provided a computer-controlled method of inhibiting bin access to unauthorised persons, the method including the steps of:
receiving in a computer processor an accelerometer data signal;
processing a selected segment of the accelerometer data signal;
comparing the processed segment with a threshold to produce a motor instruction signal;
sending the motor instruction signal to a lock motor.

In one embodiment the method further includes the steps of:
receiving in the computer processor a signal strength threshold data signal;
measuring the strength of the data signal;
comparing the data signal strength with the threshold data in the threshold data signal;
sending a motor instruction signal to a lock motor to lock the lock if the measured strength is below the threshold in the signal.

In one embodiment the threshold data signal includes a code for authorisation.

In one embodiment the method further includes the step of authorising the code by comparing it with codes disposed in a database.

In one embodiment the range monitoring module is configured to assess the strength of a signal from the base station relative to signal data sent with the signal.

In one embodiment the range monitoring module is configured to authenticate the signal from the base station by comparing code data with a lookup table.

In one embodiment the movement monitor module is configured to assess the movement of the bin relative to a threshold using an algorithm.

In one embodiment a lock control module is provided and is configured to move a latch to an unlock position if the range monitoring module and the movement monitor module assess the bin as being distal the base station and its movement being above the threshold.

In one embodiment the lock control module causes a motor to move the latch to the unlock position.

In one embodiment the range monitoring system includes a base station mounted in a loading zone and a mobile lock housing mounted on the bin.

In one embodiment the base station includes a transmitter or receiver or detector which in use transmits or receives and measures the variation in strength of, and/or delay time in receiving ultrasonic waves, Infra-red light, laser energy, microwaves, or radio waves.

In one embodiment the lock housing includes a transmitter or receiver or detector which in use transmits or receives and measures the variation in strength of, and/or delay time in receiving ultrasonic waves, Infra-red light, laser energy, microwaves, or radio waves.

In one embodiment the lock housing and/or the base station includes a computer processor which includes an RSSI element.

In one embodiment the lock housing computer processor includes a memory, one or more antennae, and a microprocessor.

In one embodiment the computer processor also includes audio output unit.

In one embodiment the lock housing also includes an accelerometer in communication with the computer processor.

In one embodiment the lock housing also includes a tilt sensor.

In one embodiment the lock housing also includes a lock bolt or catch drive in communication with the computer processor to drive the lock bolt or catch.

In one embodiment the lock drive includes a gear drive.

In one embodiment the lock includes a movable catch.

In one embodiment the movable catch is biased to the unlock and/or lock position.

In one embodiment the lock drive includes a pneumatic drive, solenoid drive or hydraulic drive.

In one embodiment the lock drive includes an AC or DC motor.

In one embodiment the lock drive includes a servo motor.

In one embodiment the computer processor is an ESP8266 module.

In one embodiment the lock mechanism includes a quick release configured to disconnect the motor from the gear to move the lock element the unlock position to quickly open the bin during collection.

In one embodiment the lock housing includes onboard power for the computer processor, the controller, the transmitter, receiver, the drive and other parts.

In one embodiment the mobile lock housing includes a manual actuator operable with a key.

In one embodiment the lock mechanism includes a proximity card reader.

In one embodiment the lock mechanism includes a biometric reader.

In on embodiment the lock mechanism includes a three-axis accelerometer and/or gyroscope or tilt sensor to monitor the angle of the bin and send that data to the computer processor.

In one embodiment the method includes the step of unlocking the bin when the accelerometer or gyroscope or tilt sensor senses an angle of the bin at more than 90 degrees to the vertical.

In one embodiment the method includes the step of recording data signals such as vertical lift acceleration, collection event signals, fall event signals, unlock and lock events in the memory and transmitting or otherwise downloading that data to a remote server.

In one embodiment the method further includes the step of, in the lock housing or base station, conducting an RSSI routine, which is monitoring the signal strength of a radio-frequency signal from the mobile housing or base station.

In one embodiment the method further includes the step of, in the computer processor, comparing vertical lift acceleration with a threshold amount stored in a memory to assess whether to actuate the RSSI routine.

In one embodiment the method further includes the step of, in the computer processor, comparing a vertical lift acceleration data stream with a threshold stored in a memory to assess whether to actuate the lock drive or quick release to drive the lock element to a locked or unlocked position.

In one embodiment the method further includes the step of, in the computer processor, actuating the RSSI routine in order to assess whether to move the lock element to a locked position.

In one embodiment the RSSI routine includes scanning one or more selected channels or frequency bands and comparing the signal strength with a threshold value stored in a memory.

In one embodiment the method further includes the step of, in the lock housing or base station, sending a signal to move the lock element to a locking position if the signal strength is below the threshold value stored in memory.

In one embodiment, the method further includes the step of, in the computer processor in the mobile lock housing or base station, causing the actuation of the lock drive to close the lock after a selected time period for collection has elapsed.

In one embodiment, the method includes the step of monitoring the quantity of onboard power in the computer processor and comparing it with a threshold stored in memory.

In one embodiment, the method further includes the step of, in the computer processing system, causing the actuation of the lock drive to drive the lock element to an open position when the on board power is below the selected threshold.

### Advantages

Advantageously, embodiments of the proposed system and method can prevent trash from being introduced when it is outside an owners' house or building, as well as preventing the contents from falling to the ground when the container falls accidentally or due to the action of an animal interference.

Advantageously, the lock of the bin lid stays open to allow loading of the bin when the bin is near the base station, and the lock closes when the bin is disposed in a collection area distal the base station, and even when the bin is toppled over for any reason.

### Clarifications

In this specification, where a document, act or item of knowledge is referred to or discussed, this reference or discussion is not an admission that the document, act or item of knowledge or any combination thereof was at the priority date:
(a) part of common general knowledge; or
(b) known to be relevant to an attempt to solve any problem with which this specification is concerned.

It is to be noted that, throughout the description and claims of this specification, the word ‘comprise’ and variations of the word, such as ‘comprising’ and ‘comprises’, is not intended to exclude other variants or additional components, integers or steps.

### BRIEF DESCRIPTION OF THE DRAWINGS

In order to enable a clearer understanding, a preferred embodiment of the technology will now be further explained and illustrated by reference to the accompanying drawings, in which:

FIG. 1 is a schematic diagram of a bin-mounted (mobile) locking system;

FIG. 2 is a flowchart of the method of operation of one aspect of the locking system;

FIG. 3 is a schematic diagram of a base station;

FIG. 4 is a prototype lock for use with the bin-mounted portion of the locking system;

FIG. 5 is an exploded view of the prototype lock pin (5A—mounted on the lid) and lock housing (5B—mounted on the bin body near the rim);

FIG. 6 is an isometric view of the prototype lock housing shown in FIG. 5B with a cover plate off to show certain mechanical parts of the lock mechanism (controller PCB and onboard power and electric motor removed for clarity);

FIG. 7 is an elevation view of the prototype lock housing shown in FIG. 6, showing the mechanical parts of the lock;

FIG. 8 is a section view of the prototype lock from FIGS. 4 to 7 shown in a locked position;

FIG. 9 is a section view of the prototype lock from FIG. 8 in an unlocked position;

FIG. 10 is a front elevation view of a bin with an embodiment of locking system, the bin having a lid disposed in an open position, and the bin being shown situated in a home zone, which is proximal a base station (also shown);

FIG. 11 is a side elevation view of the bin with locking system shown in FIG. 10, again shown situated in a home zone, which is proximal the base station;

FIG. 12 is a detail view of the bin of FIG. 11, showing the detail of the lock assembly, the bin is shown with the lid in a closed position;

FIG. 13 is an isometric view of the bin lock assembly of FIGS. 10 to 12, with the two main parts shown: the strike assembly and the latch assembly;

FIG. 14 is a side elevation section view of the two main parts of the bin lock assembly, as shown in FIG. 13: the strike assembly and the latch assembly;

FIG. 15 is an isometric view of the latch assembly shown in a locked position with the housing not shown for clarity;

FIG. 16A is an isometric view of the strike assembly shown in the locked position, with the housing not shown for clarity;

FIG. 16B is an isometric view of the strike assembly shown in the unlocked position with the housing not shown for clarity;

FIG. 17 is an isometric view of the base station;

FIG. 18 is an isometric view of the base station with the housing removed for clarity;

FIG. 19 is a screenshot showing features of an app for controlling the lock arrangement;

FIG. 20 is a flowchart showing events in a movement monitor module in a processor for controlling the lock; and

FIG. 21 is a flowchart showing events in a range monitor module in a processor for controlling the lock.

### DETAILED DESCRIPTION OF AN EXAMPLE EMBODIMENT

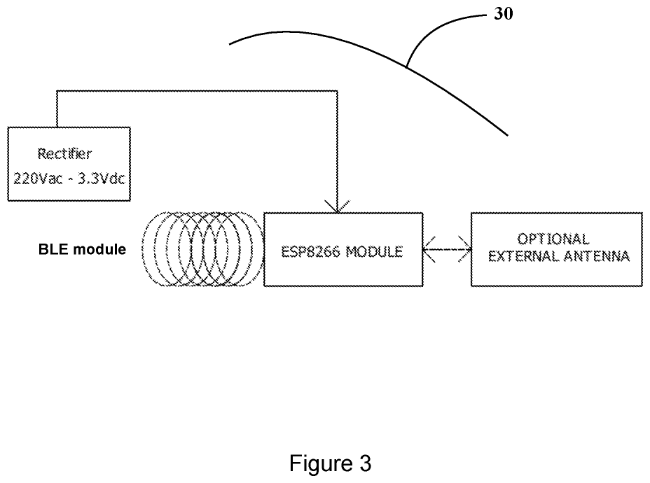

Referring to the drawings there is shown a computer-controlled lock system for a bin 5, the lock system generally indicated at 10 and including: a range monitoring module 20 including a computer processor 22 configured to monitor the proximity of the bin to a base station 30 (FIG. 3). The lock system 10 also includes a movement monitoring module 40 including a computer processor 22 to monitor when the bin is being moved. Finally for this high-level introduction to the concept, there is shown a lock arrangement 50 in communication with the range monitoring module 20 and the movement monitoring module 40 to unlock the bin when the bin is proximal the base station 30 and when the bin is being collected, and to lock the bin when the bin is distal the base station 30 and not being collected.

The components in the system 10 work together to implement a computer-controlled method of inhibiting bin access to unauthorised persons, the method including the steps of: monitoring proximity of a bin to a base station 30 with a range monitoring module 20 having a computer processor 22 to monitor proximity of the bin to the base station 30; monitoring bin movement with a movement monitoring module 40 in a computer processing system operatively connected to a movement monitoring module 40; and unlocking a bin lock 50 with a lock management module 55 of a computer controller when the range monitoring module 20 detects that the bin is proximal the base station 30 and locking the bin lock 50 when the range monitoring module 20 detects that the bin is distal the base station 30.

The components can also unlock the bin lock 50 with the computer controller when the movement monitor 40 detects that the bin is being lifted and the range monitoring module 20 detects that the bin is distal the base station 30.

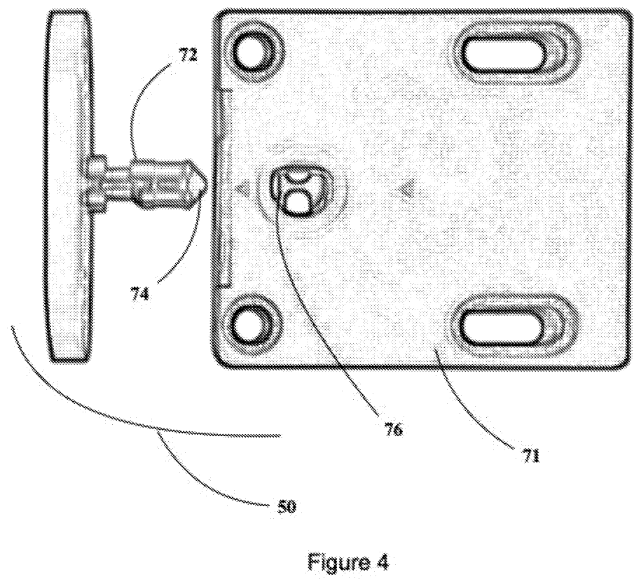

FIG. 4 shows some additional mechanical detail of the lock 50. First, a pin 72 has a lead in 74 on an outer end, the advantage being that an off-centre lid can be accommodated. The lock 50, advantageously, can be kept open and/or closed without substantially any energy expenditure once you are in a locked or unlocked state. This is because the lock 50 includes a catch 76 which is driven across, behind the head 74 of the pine 72, which keeps the pin 72 in the lock body 71. The catch 76 may be driven across by a rack and pinion arrangement 75.

The lock body 71 has a ramp 80 to deflect refuse from the lock body 71 to inhibit its catching on the body 71. With the ramp 80, refuse from inside the bin is deflected out and into a collection truck (not shown).

On board power is shown in the form of batteries 90.

Computer controller is shown at 20 in the bin lock body 71 and the position where the DC motor 95 is shown is also indicated.

### Operation

This system 10 when in use grants access only to authorised users of the bin 5. It does that generally by maintaining the bin in an unlocked state when it is near the base station 30 but locks the bin 5 when it moves a selected distance from the base station 30. The reasons for this operating method are so that authorised people can access the bin 5 to fill it when it is near the base station, but only one or more of a selection of movements will allow the unlocking of the bin when it is on the street, far from the base station, waiting for collection. One of the selection of movements which allows unlocking is a lifting movement by a garbage collection truck.

When the bin 5 is near the base station 30 the system 10 keeps the lock 50 in an unlocked position so as to allow relatively free or unlocked access to a bin 5. This is because there is an unlock key data signal being broadcast by the base station 30. The key data signal is in the form of a BLE data signal which includes a code. The code includes a 32-bit key data string, and an authorisation module 65 in the processor 22 processes the code by comparing it with a database to check whether there are any matching 32-bit key codes stored there. If there is a match, the unlock key data signal is observed, and the signal strength is monitored by the range monitor module 20 as described herein, and the lock stays open. If there is a match, but the range monitor module 20 assesses the signal as too far away, as described, then the lock is moved to the locked position.

The movement monitoring module 40 with the computer processor 22 limits access only to authorised refuse collectors when it is remote from the base station. One of the ways that the bin lock system 10 does this is by consulting a movement monitor 40, which in use confirms that the processed result of a vertical acceleration signal of the bin is greater than a threshold. The processor may also consult the range monitoring module 20 to double check that a radio frequency signal from the base station 30 is below a selected threshold in power level measured in dB, or the processor may simply conduct a state check that the lock is in the locked position, or an out of home state is checked. If the movement module 40 and the state check conditions are achieved, then the system 10 knows that the bin is being collected and emptied in to the garbage truck, and the processor 22 causes the unlocking of the bin 5. At other times when the bin is away from the base station 30, the bin lock 50 remains closed even when the bin falls over.

### App Operation

There is also provided a software application for execution on a mobile device which may operate the lock management module 55 on the processor 22. The application is configured to cause the mobile device to transmit a key data signal to the authorisation module 65 which then instructs the lock management module 55 to move the motor to open the latch.

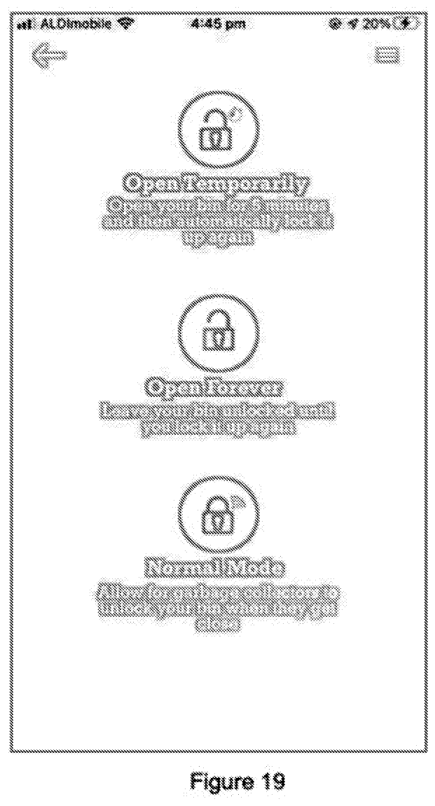

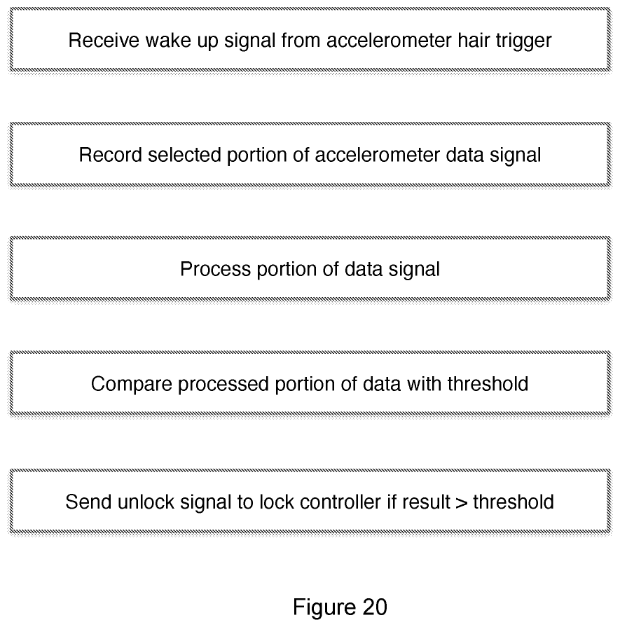

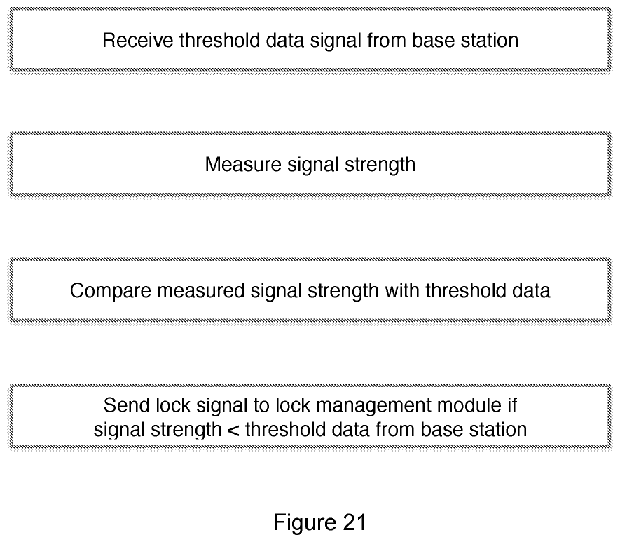

It can be seen from FIG. 19 that the app can cause the bin lock to release for a short time or a permanent open until a lock signal is received.

The app may also provide the operator with data, in that commercial bin customers can request a bin pick up.

### Processor

Computer processor 22 is a microcontroller 23 which (as with all microprocessors) has a relatively high consumption in times when it is active, particularly relative to times when it is in Deep-sleep mode.

The processor 22 requires 1.8V to 3.6V.

### Onboard Power

There is on board power 99 in the form of batteries (2× or 4×1.5V AA batteries) arranged to provide 6V. One purpose of the 6V is to power the processor 22, but as mentioned, the processor 22 requires only 1.8V to 3.6V. That means we need to convert the voltage from 6V to something like 3V.

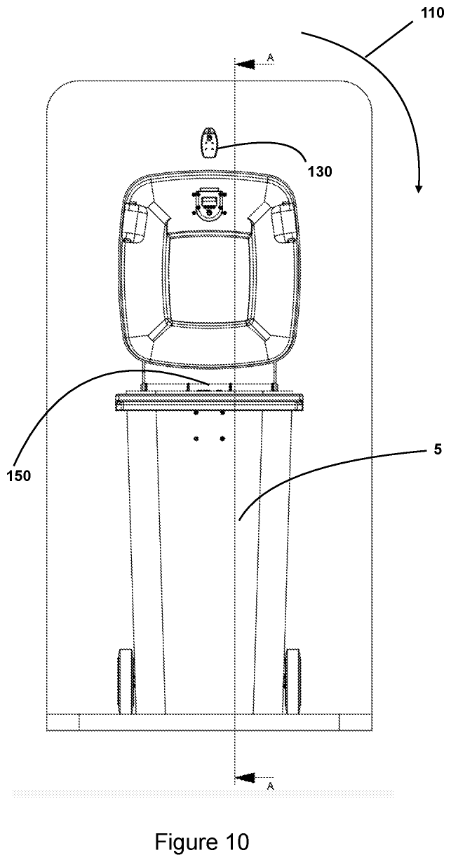

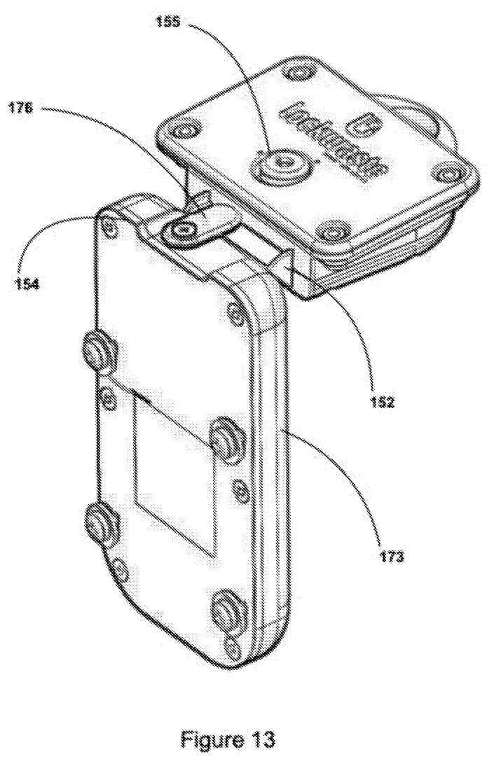

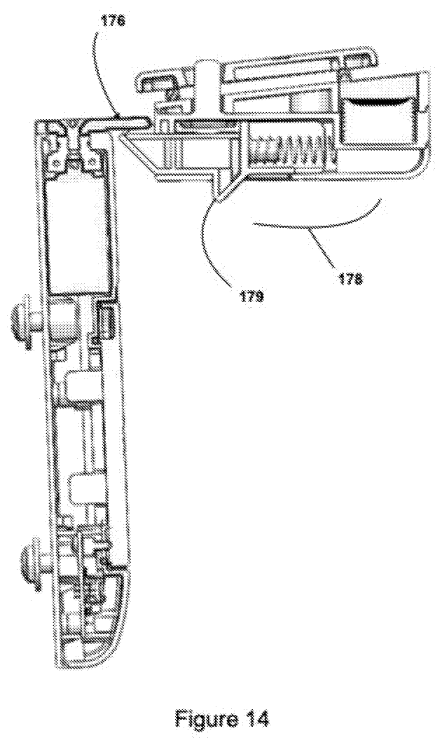

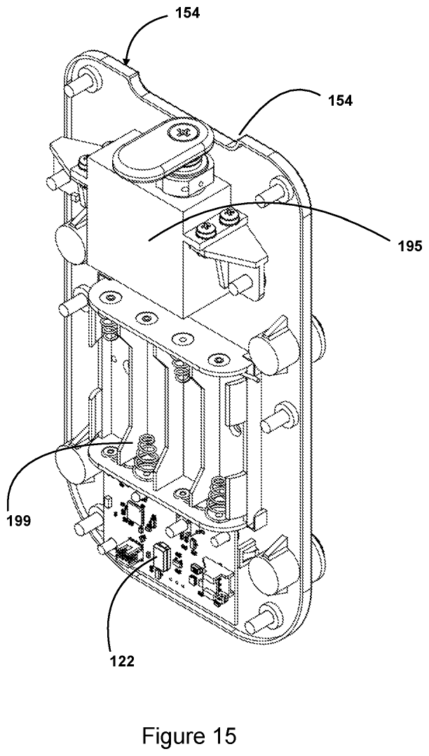

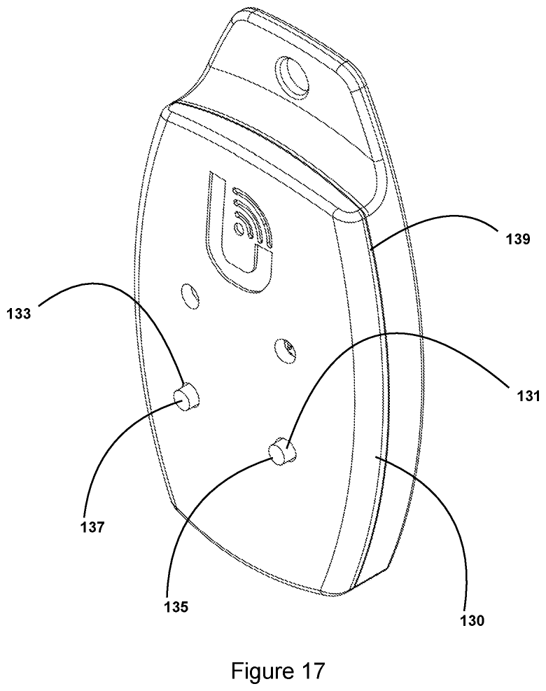

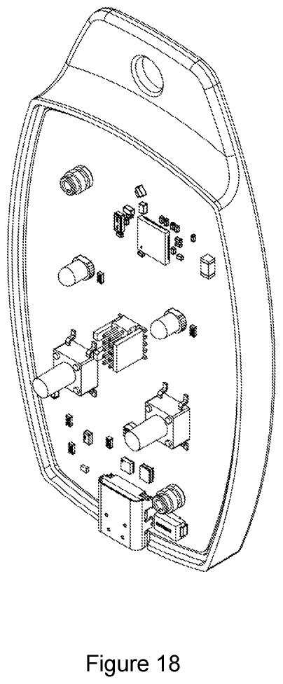

There are two ways contemplated to convert the voltage: first, a Buck Converter, which is efficient under load but with a relatively high quiescent current, and a Linear Regulator, which uses more power under load but is capable of a lower quiescent current than a Buck Converter. The inventors carried out tests with both and the embodiment shown in FIGS. 10 to 19 shows a PCB in the lock 150 that can take either part. The inventors conducted use case analyses and determined that the system 10 in normal use spends a sufficient amount of time in deep sleep, which draws only quiescent currents that a linear regulator was assessed as being more efficient than a buck converter.

So that the on board power 99 lasts as long as possible, the method of the present technology seeks to keep the controller 22 in a deep sleep state as long as possible without jeopardising precise or accurate control.

It is also contemplated that the onboard power could be arranged such that there are two batteries in series and two in parallel. This would provide a voltage of 3V which would mean that the microcontroller could be powered with no voltage conditioning. Using this approach, the voltage for the microcontroller 23 would sag when the motor is drawing current, especially when the batteries are near the end of their life. Also, while the 3V arrangement can drive some motors, it is not particularly suitable to drive a servo motor, so it is not preferred in the embodiment shown in FIGS. 10 to 18.

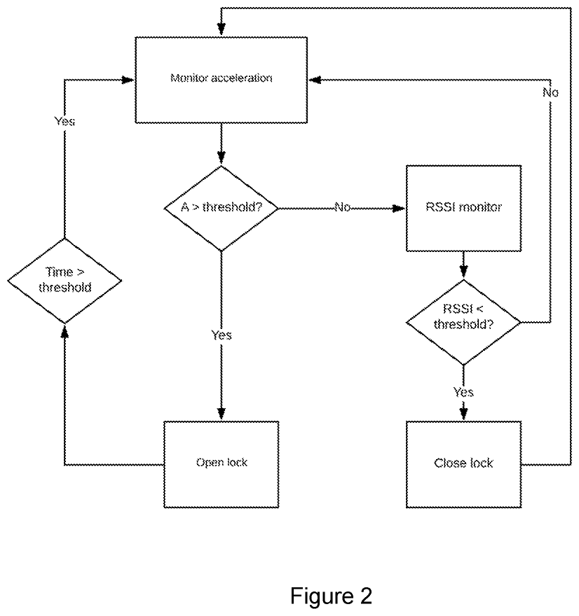

Thus, the method shown in FIG. 2 keeps consumption low. There are two useful moments when the processor 22 should wake up to exercise control over the lock 50. First: when the bin moves to a position distal the base station (loading bay) out of range (to lock the bin) and the second is when the truck picks up the container to dump it and the trash falls out into the truck (to unlock the bin).

### Range Monitoring

The bin lock system 10 broadly speaking provides two zones of operation: A home zone 3, which is proximal the base station 30, and an out of home zone 4, which is distal the home zone. The base station 30 facilitates the provision of the two zones 3 and 4 by use of a radio transmitter beacon 39 which is configured to transmit a secure message which the bin lock 10 is configured to receive and process.

The range monitoring module 20 includes a wireless module 45 which is configured to receive secured wireless messages from the radio transmitter beacon 39. The wireless module 45 includes a power sensor 47 which measures the power level or amplitude of the radio message from the beacon 39. The range monitoring module 20 is configured to authorise the messages using a lookup table and also assess the amplitude of the radio message against a power threshold signal unit in the message itself to identify whether it is in the home zone or out of the home zone.

The dimensions of the home zone 4 can be configured using an adjuster module 31 disposed on the base station 30. The adjuster module 31 includes volume control 33 which includes a volume increase button 35 and a volume decrease button 37. These buttons 35 and 37 adjust the required receive RSSI threshold that is transmitted from the beacon to the bin lock 50, along with a key code. That is, the base station 30 is configured to transmit a message to the range monitor 20 in processor 22. The message from the base station includes a security code and a signal strength unit. The range monitor 20 then assesses the signal strength data received by the power sensor 47 with the power level data in the message from the beacon 39 and then decides whether the bin lock 50 is in the home zone 3 or in the out of home zone 4. If the signal strength data from the power sensor 47 is above the threshold data sent by the beacon 39, then the bin lock 50 is in the home zone. If the signal strength data from the power sensor 47 is below the threshold data sent by the beacon 39, then the bin lock 50 is in the out of home zone, distal the base station 30.

Advantageously, being able to adjust the required threshold at the base station 30, the user can adjust the location of the boundary between Home Zone (HZ) and Out Of Home Zone (OOHZ) without needing to access the bin lock 50. Accessing the bin lock 50 for this purpose is impractical because there may be many bin locks and any buttons and user interfaces on the bin lock need to be under the battery lid so that they are protected from bin juice and weather.

The RSSI signal strength check should be done as quickly as possible, to keep battery 90 consumption down; below 100 ms is preferable. With the computer processor being an ESP8266 microprocessor it is possible to detect signals in approximately 70 ms (depending on whether the BLE radio on the base station 30 is turned off or not). To achieve detection in such a short time, the microprocessor ESP8266 is programmed not to scan the 14 possible channels of the band, but the lock microprocessor and the emitter microprocessor are configured to transmit and receive in a tight, defined bandwidth; only one channel. Thus, with this change, the scans of the signals go from 2.5 seconds to 70 ms.

To configure the threshold radius, which is the distance between the base station 30 and a collection zone on the street outside the house or building (not shown), the bin is moved by a user to the collection zone on the street. An actuator button (not shown) is depressed and the microcontroller will read the signal strength that reaches it at that time (it may be several readings to be able to make an average of the signal strength) and save it in non-volatile memory to be used as a threshold to activate the lid.

The computer processor 22 also monitors battery 90 voltage so that, when the batteries are close to dead (below a selected voltage threshold), the computer processor 22 is caused to drive the lock 70 to the open position, so as to leave the bin lids accessible to load or remove the garbage. The microcontroller ESP8266 has a built in ADC that can monitor battery 90 voltage without the need to spend an analog pin.

A buzzer 95 is also provided to notify a user of commands that leave or reach the lock during programming such as configuration commands, opening and closing, and low level of batteries.

Although it is not represented in the schematics, it is contemplated to provide a very low consumption capacitive fingerprint reader (model Grow R503) of approximately 2 uA to 3.3V when it is in sleep mode waiting to activate by contact, that would be connected by UART interface to the microcontroller and that would have the ability to save and autoencode the footprints we want. This would have a method to open the container or close it without using the mechanical wrench.

### Movement Monitoring

To keep power consumption low, rather than continually checking on the signal strength of a wifi signal, there is provided an accelerometer 80, which has a virtually autonomous operation and an extremely low operating current. The make and model is Analog Devices' ADXL362.

The accelerometer 80 includes a hair trigger, which is a circuit which wakes up the processor 22 whenever a very small acceleration in any of the three axes is detected.

One step of the method provided by the present technology is to monitor when the bin is moving in one or more selected patterns. The processor 22 is disposed in a sleep mode until the accelerometer detects movement, which causes the processor 22 to wake up to assess what kind of movement is happening and act accordingly.

So, the method shown in FIG. 2 shows the step of monitoring the acceleration by taking a measurement and checking the FIFO register of the accelerometer 80 to check if there has been an acceleration greater than a threshold on the Z axis or whether there is one or more movement conditions/signals/patterns/thresholds being met.

The processor 22 processes a bin lift detect algorithm, the processing of the algorithm commencing when the accelerometer 80 detects movement. The processor 22 then begins to sample data from the accelerometer at 100 Hz and to process that data signal. in operation, the algorithm has very little time to assess the movement because it needs to give the motor as much time as possible to perform the unlock movement. Preferably the unlock movement where the motor rotates the latch from the lock position to the unlock position takes less than a second, because after a certain angle of tilt, the rubbish in the bin 5 comes to rest on the inner face of the bin lid 6 and unlocking then increases the load on the motor.

If the movement data signal from the accelerometer fits a selected pattern and is above a threshold, the controller 22 is faced with the situation where the truck is lifting the bin up and, therefore, the controller quickly opens the lock 50 so that the lid quickly opens and the garbage falls out. Once the lid is opened the controller could sleep again for a period of time on a timer on the processor 22, or until the controller reviews the FIFO register and identifies that there has been no acceleration for longer than a threshold time period, and it understands that the bin is on the ground again. At that point, the controller 22 will close the lock 50 again until the next movement.

If the monitoring of the Z-axis acceleration yields a result that is less than the gravity threshold, the computer processor 22 is caused to periodically check the RSSI for proximity to the base station 30, or merely again monitor the FIFO register such that there has been no movement for a threshold time and then conduct an RSSI to check if the bin is proximal the base station 30.

The signal from the Z-axis of the accelerometer is noisy but a useful algorithm is set out below, written in C. The algorithm can be seen to take the last 16 data points when the Z-axis signal is sampled at 100 Hz. Then the data points are added together as a form of numerical integration to get an integrated result. The integrated result is compared with a threshold and then the comparison is sent to the lock controller. Either an unlock signal is sent or a lock signal is sent.

```
void initializeLiftDetector( ) {
  for (int i = 0; i < numberOfCoeffs; i++) {
    pDelayBuffer[i] = −offset;
  }
  AfterArea = 0;
  countAfter = 0;
}
int pushOntoLiftDetector(double inputValue) {
  // shift everything right by one
  for (int i = numberOfCoeffs − 1; i > 0; i−−) {
    pDelayBuffer[i] = pDelayBuffer[i − 1];
  }
  // push the new value onto the front of the MovingAverageFilter
  pDelayBuffer[0] = inputValue;
  // calculate the area of the before part of the filter (the first half)
  float crossThreshold = 1;
  AfterArea = 0;
  for (int i = 0; i < numberOfCoeffs; i++) {
    double currentSample = pDelayBuffer[i] + offset;
    if (pDelayBuffer[i] == 0) {
      break;
    }
```

Motor with Absolute Position Command

The motor 95 could include encoders and other items but the one shown is a servo motor 96 and includes a gearbox 97. The motor 95 is capable of assessing positional feedback within the motor (though this feedback is not available to the microcontroller). It is therefore contemplated that the processor 22 can command the motor 95 to move to a selected position rather than just for a certain time or for a certain angle displacement.

### Beacon Operation

To allow the bin lock 10 to sleep as much as possible and to therefore extend its battery life as much as possible, the beacon 39 has a high rate of message transmission. Also, to save more energy, the bin lock range monitoring module 20 does not transmit back to the beacon 39, but operates in advertising mode. The beacon 39 sends messages frequently enough, to allow the bin lock 10 to sleep most of the time and only to wake up once every one or two minutes for half a second or so to catch a threshold message from the beacon 39. This high rate of transmission of beacon 39 messages means that the beacon is configured to be powered. It can be seen that the base station 30 has a power cable input 38 at its base. This arrangement means that the system pays a high price in terms of power at the base station 30 for a lower price in terms of power for the bin lock 10.

### Second Embodiment

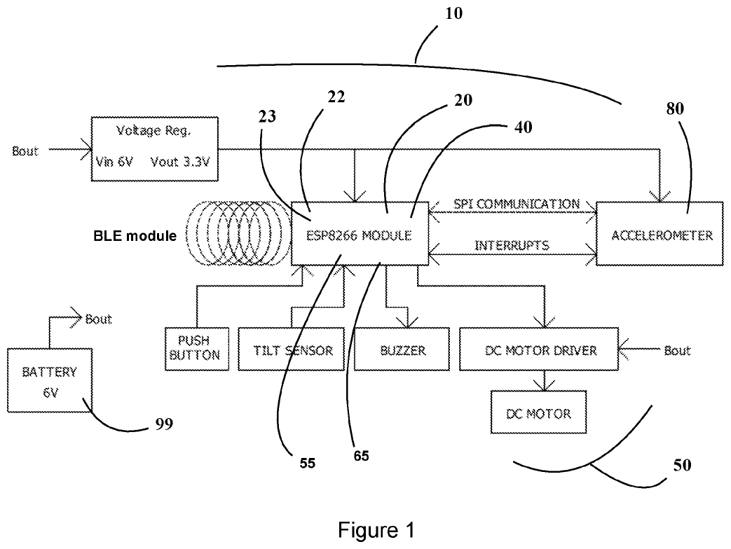

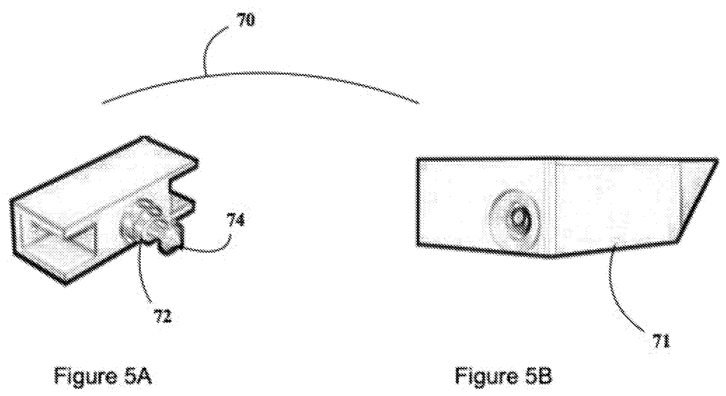

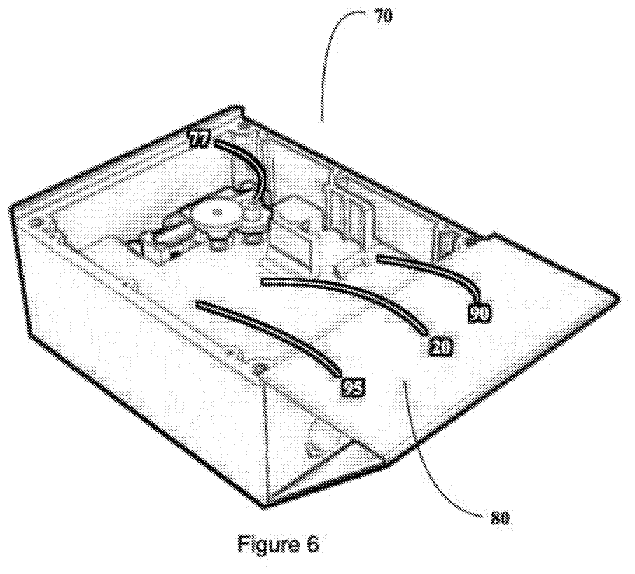

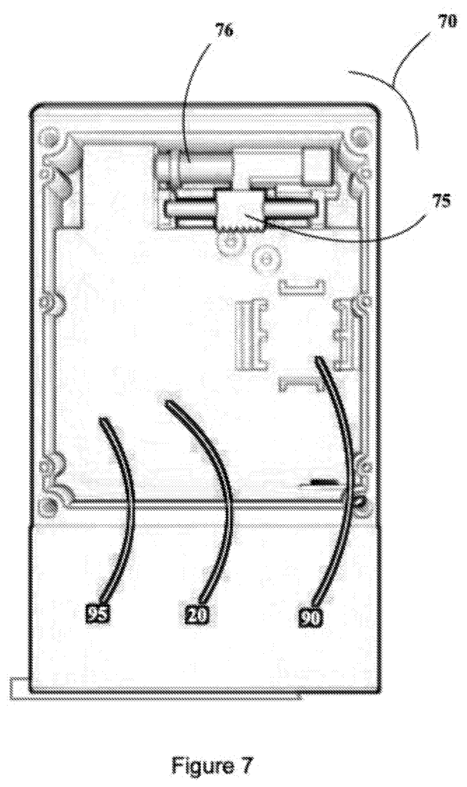

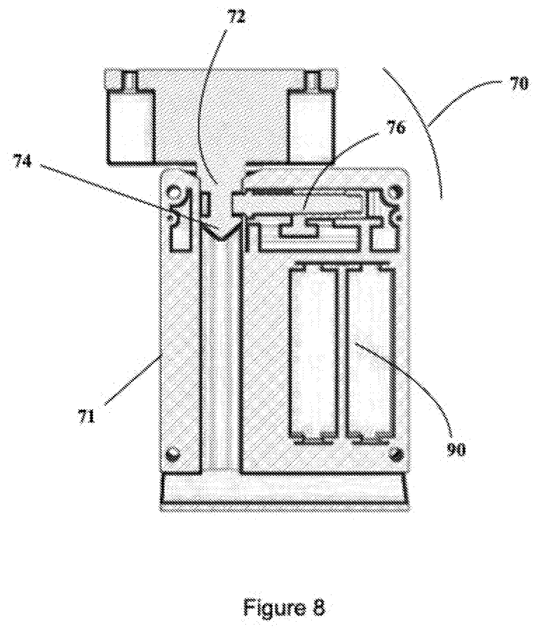

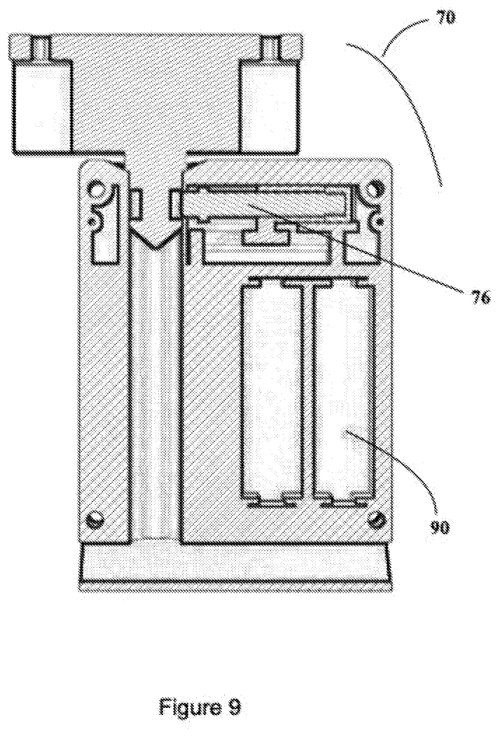

There is shown a second embodiment in FIGS. 10 to 18 which operates in a very similar way to the embodiment described and shown in FIGS. 1 to 9. Like numerals in FIGS. 4 to 18 denote like features, for example 10, 110. The embodiment in FIGS. 10 to 18 operates with the same method and schematic structure as shown in FIGS. 1 to 3.

While the method that is implemented by the two embodiments are the same, there are a few structural differences between the embodiments, which will become clear form the description below.

The computer controlled lock system 110 includes a lock arrangement 150, a range monitor 120 and a movement monitoring module 140.

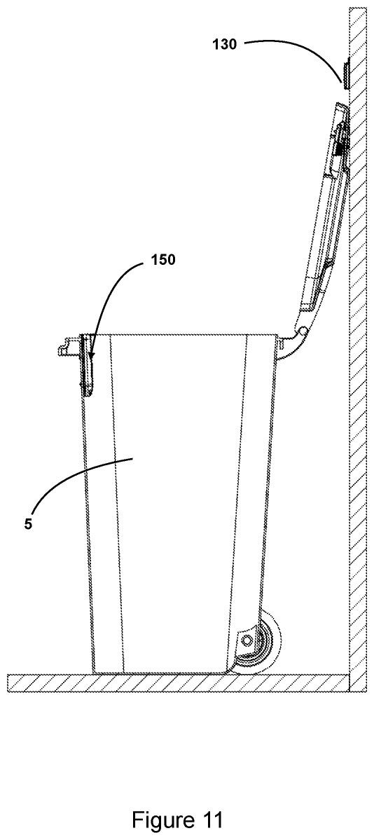

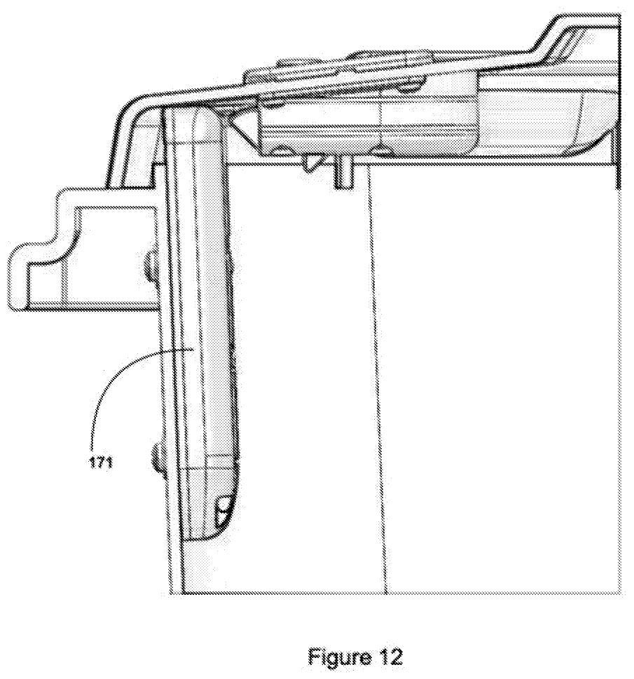

The lock system 110 includes a lock body 171 which includes a housing 173 for housing the range monitor 120 and movement monitoring module 140. The lock system 110 includes a latch 176 which is configured to be rotatably driven by a motor 195 between a locked position shown in FIGS. 12 to 15 and an unlocked position shown in FIGS. 10 and 11. The housing 173 includes shoulders 154 to protect the latch 176 when the bin is inverted for cleaning.

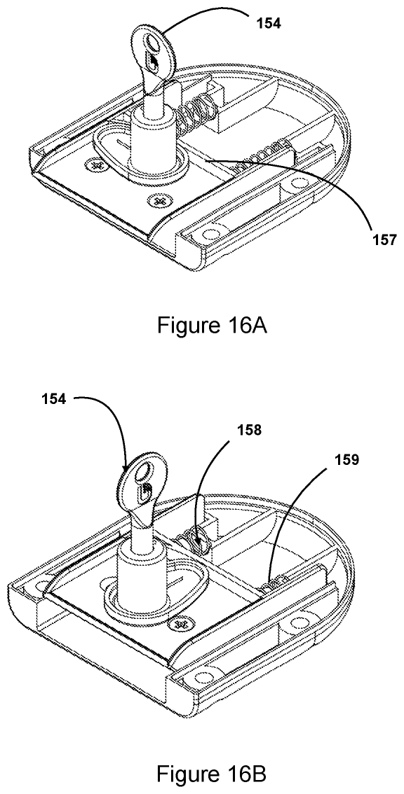

The lock system 110 also includes a catch 152. The catch 152 is movable for manual release, and it can move between a locked position shown in FIG. 16A and an unlocked position shown in FIG. 16B. The catch 152 is configured to be unlocked from the outside or the inside of the bin 5. The external actuator is a key 154, which cooperates with a lock 155 and includes a detent (not shown) so as to be retainable in the lock when the key is turned to the unlock position. The lock 155 includes a cam 156 which operates on a follower 157 to push against a biasing force 158 in the form of springs 159.

A safety release 178 is also provided. In that release, the follower 157 is manually operable by an actuator handle 179 in order to release from the inside. The handle 179 slides the catch 152 away from the latch 176 to release.

The power supply is shown at 199, the motor and gearbox is shown at 195.

There is provided an NFC chip holder in the power supply compartment which a reader can read to determine who is the owner of the bin. Using the chip, a service provider may send invoices to the owners of the bin.

Modifications and improvements to the invention will be readily apparent to those skilled in the art. Such modifications and improvements are intended to be within the scope of this invention.

1. A computer-controlled lock system for a bin, the lock system including:
a movement monitoring module including an accelerometer and a computer processor to monitor when the bin is being collected,
a lock arrangement in communication with the movement monitoring module configured to unlock the bin when the bin is being collected and to lock the bin when the bin is not being collected, and
a range monitoring system including a computer processor to monitor the proximity of the bin to a base station,
wherein the range monitoring system includes a wireless module for receiving and measuring strength of wireless signals from a base station.

2. (canceled)

3. (canceled)

4. The computer-controlled lock system in accordance with claim 1 wherein the wireless module includes a BLE unit configured to operate in advertising mode.

5. (canceled)

6. The computer-controlled lock system in accordance with claim 1 wherein the range monitoring system is configured to receive a BLE data signal which includes a threshold radio signal strength data, and assess the signal strength data with the measured strength, to output a home zone data element if the measured strength is above the threshold data set in the message, and an out-of-home zone data element if the measured strength is below the threshold data in the message.

7. (canceled)

8. The computer-controlled lock system in accordance with claim 1 wherein the base station includes a volume control to vary the power of the threshold data signal.

9. (canceled)

10. The computer-controlled lock system in accordance with claim 1 wherein the lock arrangement includes a key management module and the threshold data signal includes a key code for security.

11. (canceled)

12. The computer-controlled lock system in accordance with claim 1 wherein the key management module includes an actuator button wherein the key management module is configured such that a long press on the actuator button will erase all key data strings from a key database except for a master key data string wherein the key management module includes a key configuration routine wherein the key management module is configured to add keys in the key configuration routine by responding to a short press of the button to cause the key data contained in any incoming message that bears a “remember me” data flag to be saved in the key database table.

13. (canceled)

14. (canceled)

15. (canceled)

16. (canceled)

17. The computer-controlled lock system in accordance with claim 1 wherein the accelerometer includes a trigger unit which includes a sensing module which activates the computer processor of the movement monitoring module to commence sampling data from the accelerometer.

18. The computer-controlled lock system in accordance with claim 1 wherein the movement monitoring module records a sample of data from the accelerometer and conducts numerical integration on the sample to compare it with a threshold to provide a threshold comparison output data.

19. The computer-controlled lock system in accordance with claim 1 wherein the movement monitoring module sends the threshold comparison output data to a lock control module which includes a latch state detector configured to detect whether the latch is in a locked position or in an unlocked position, the latch state detector being configured to record the latch state in an onboard memory.

20. (canceled)

21. (canceled)

22. The computer-controlled lock system in accordance with claim 1 wherein the lock control module includes a zone detector configured to detect whether the lock is in a home zone proximal a base station or whether the lock is in an out of home zone distal the base station,
wherein the lock control module is configured to record whether the lock is in the home zone or in the out of home zone, in memory.

23. (canceled)

24. The computer-controlled lock system in accordance with claim 1 wherein the lock control module is configured to receive the output data from the range monitor to lock the lock arrangement when the output data indicates that the bin is in the out of home zone.

25. (canceled)

26. The computer-controlled lock system in accordance with claim 1 wherein a lock housing is provided that includes shoulders to protect the latch when the bin is inverted for cleaning.

27. The computer-controlled lock system in accordance with claim 1 wherein the lock system includes a catch which is movable for manual release, such that it can move between a locked position and an unlocked position,
wherein the catch is configured to be unlocked from the outside or the inside of the bin,
wherein an outside actuator is a key, which in use cooperates with a lock and includes a detent so as to be retainable in the lock when the key is turned to the unlock position.

28. (canceled)

29. (canceled)

30. The computer-controlled lock system in accordance with claim 1 wherein the lock includes a cam which operates on a follower to push against a biasing force in the form of springs wherein the follower is manually operable by an actuator handle in order to release from the inside.

31. The computer-controlled lock system in accordance with claim 1 wherein there is provided a catch safety release wherein the handle slides the catch away from the latch to release.

32. (canceled)

33. (canceled)

34. A computer-controlled method of controlling bin access to unauthorized persons, the method including the steps of:
receiving in a computer processor an accelerometer data signal;
processing a selected segment of the accelerometer data signal;
comparing the processed segment with a threshold to produce a motor instruction signal;
sending the motor instruction signal to a lock motor;
receiving in the computer processor a signal strength threshold data signal;
measuring the strength of the data signal;
comparing the data signal strength with the threshold data in the threshold data signal; and
sending a motor instruction signal to a lock motor to lock the lock if the measured strength is below the threshold in the signal.

35. (canceled)

36. The computer-controlled method in accordance with claim 34 wherein the threshold data signal includes a code for authorization and
the method further includes the step of authorizing the code by comparing the code with stored codes.

37. (canceled)

38. The computer-controlled method in accordance with claim 34 further including the step of range monitoring module is configured to assessing the strength of a signal from the base station relative to signal data sent with the signal.

39. (canceled)

40. (canceled)

41. The computer-controlled method in accordance with claim 34 wherein a lock control module is provided and is configured to move a latch to an unlock position if the range monitoring module and the movement monitor module assess the bin as being distal the base station and its movement being above a movement threshold.

42. (canceled)

43. A computer-controlled method of inhibiting bin access to unauthorized persons, the method including the steps of:
monitoring proximity of a bin to a base station with a range monitor having a computer processor to monitor proximity of the bin;
monitoring bin collection movement with a computer processor having a lift monitor; and
unlocking a bin lock with a computer controller when the range monitor detects that the bin is proximal a base station and locking the bin lock when the range monitor detects that the bin is distal the base station and/or unlocking the bin lock with a computer controller when the lift monitor detects that the bin is being lifted and the range monitor detects that the bin is distal the base station.

44. (canceled)
